(19) United States
(12) Patent Application Publication
(10) Pub. No.: US 2013/0188174 A1
(43) Pub. Date: Jul. 25, 2013

(54) Configurable Chiral Fiber Sensor

(71) Applicants: Victor Il'ich Kopp, Fair Lawn, NJ (US); Jonathan Singer, New Hope, PA (US); Daniel Neugroschl, Suffern, NY (US)

(72) Inventors: Victor Il'ich Kopp, Fair Lawn, NJ (US); Jonathan Singer, New Hope, PA (US); Daniel Neugroschl, Suffern, NY (US)

(73) Assignee: CHIRAL PHOTONICS, INC., Pine Brook, NJ (US)

(21) Appl. No.: 13/354,681

(22) Filed: Jan. 20, 2012

(51) Int. Cl. G01N 21/17

(52) U.S. Cl. 356/73.1

(57) ABSTRACT

The inventive configurable chiral fiber sensor is readily configurable for use in a variety of applications (such as applications involving pressure and/or temperature sensing), and which is particularly suitable for applications in which the sensing of a presence or absence of the target sensed event (e.g., specific minimum pressure or minimum temperature) is required. Advantageously, the inventive configurable chiral fiber sensor utilizes light sources, photodetectors, and related devices for sensor interrogation.

### FIELD OF THE INVENTION

The present patent application claims priority from the commonly assigned co-pending U.S. provisional patent applications Ser. No. 61/138,912, entitled “CHIRAL FIBER CIRCULAR POLARIZER”, and Ser. No. 61/433,825, entitled CONFIGURABLE CHIRAL FIBER SENSOR”.

### BACKGROUND OF THE INVENTION

Fiber-based sensors have many important applications in .a wider range of industries. However, such sensing systems often suffer from a number of common disadvantages, such as complexity of interrogation systems, and vulnerability of the fiber sensing elements and the links between the sensing elements and the interrogating systems to events and stimuli that are not intended to be sensed but that may nevertheless impact the sensor system performance, accuracy and reliability.

### BRIEF DESCRIPTION OF THE DRAWINGS

FIG. 1 is a schematic diagram of a side view of a first exemplary embodiment of the configurable chiral fiber sensor of the present invention; and

FIG. 2A is a schematic diagram of a side view of a second exemplary embodiment of the configurable chiral fiber sensor of the present invention; and

FIG. 2B is a schematic diagram of a side view of a third exemplary embodiment of the configurable chiral fiber sensor of the present invention.

### SUMMARY OF THE INVENTION

The configurable chiral fiber sensor of the present invention is readily configurable for use in a variety of applications (such as applications involving pressure and/or temperature sensing), and which is particularly suitable for applications in which the sensing of a presence or absence of the target sensed event (e.g., specific minimum pressure or minimum temperature) is required. Advantageously, the inventive configurable chiral fiber sensor utilizes light sources, photodetectors, and related devices for sensor interrogation.

In at least one exemplary embodiment thereof, the inventive configurable optical chiral fiber sensor, comprises at least one predefined compatible light source operable to generate a light signal having predefined polarization characteristics, an optical fiber sensing component, operable to permit the light signal to be received from the at least one light source, and to be circulated therethrough, at least one transducer means, positioned proximal to the optical fiber sensing component, for causing at least one corresponding distortion in the predefined polarization characteristics of the circulating light signal, a sensor interrogation system, operable to detect the at least one distortion to produce a corresponding at least one sensor output; and an optical fiber link of a predetermined length connected between the optical fiber sensing component and the sensor interrogation system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF THE INVENTION

The system and method of the present invention advantageously overcome and address the drawbacks of previously known fiber-based sensors and provide additional beneficial features.

The inventive configurable chiral fiber sensor, in various embodiments thereof, is readily configurable for use in a variety of applications (such as applications involving pressure and/or temperature sensing), and is particularly suitable for applications in which the sensing of a presence or absence of the target event to be sensed (e.g., a specific minimum pressure or minimum temperature value) is required.

In one embodiment thereof, the inventive chiral fiber sensor comprises a modified optical fiber sensing portion (e.g., such as a sensing tip operable to reflect polarized light), through which light signals with specific polarization characteristics (e.g., linearly or circularly polarized light) are circulated (e.g., by use of appropriately interconnected light sources, circulators, photodetectors, and a WDM combiner). An occurrence of a target sensed event is translated to the sensing portion of the chiral fiber sensor (e.g., through an appropriately configured and positioned transducer), and causes a distortion of the polarization characteristics of the light signal being circulated through the tip, that is subsequently picked up by a photodetector or equivalent and “sensed”.

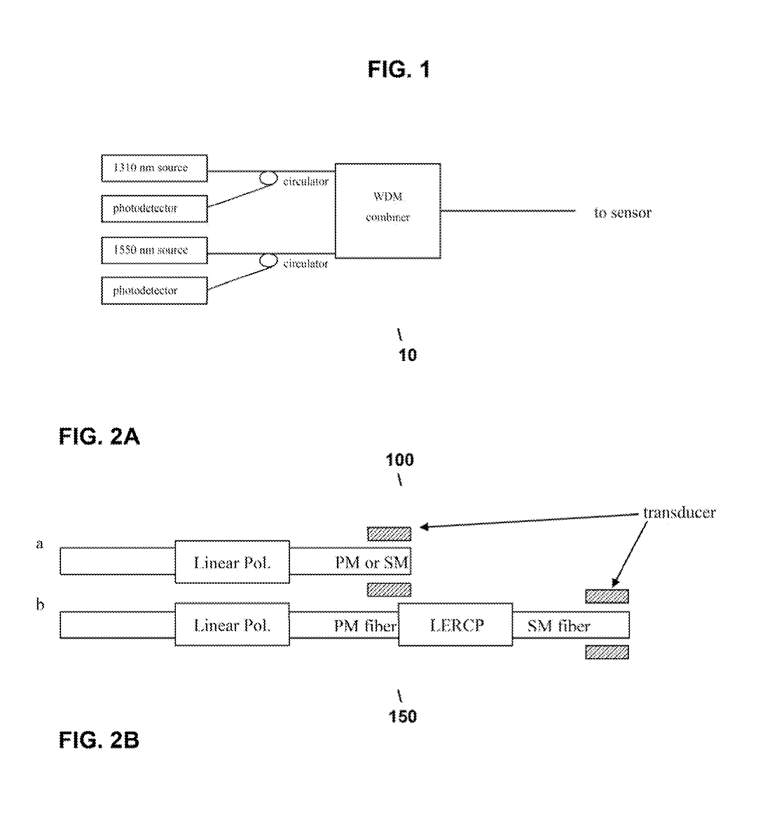

Referring now to FIG. 1, an exemplary embodiment of the inventive configurable chiral fiber sensor is shown as a chiral fiber sensor 10. In at least one exemplary embodiment thereof, the chiral fiber sensor 10 comprises an optical fiber sensing component connected, through an optical fiber link of a desired length to the sensor 10's interrogation system, for example comprising at least one light source (e.g., shown by way of example only in FIG. 1 as a pair of light sources (e.g., LEDs), one operating at a 1310 nm wavelength (e.g., not working as a polarizer), and the other operating at a 1550 nm wavelength (e.g., working as a polarizer), each connected to a corresponding circulator which are in turn connected to a WDM combiner that communicates with the sensing component through the optical fiber link.

The sensing component may be advantageously configured for various sensing applications and desired sensing parameters. For example, for pressure sensing applications, the sensing component can be implemented in a tip sensing geometry, with an optical fiber tip that incorporates a reflector that may be implemented as a coated mirror or, alternately, may simply be configured as a cleaved fiber end.

Referring now to FIGS. 2A and 2B, various exemplary embodiments of the sensing components 100, 150 that may be advantageously utilized as the sensing component of the chiral fiber sensor 10 of FIG. 1, are shown. Each of the sensor components 100, 150 includes a linear polarizer, which, in sensor component 100 of FIG. 2A is followed by a sequentially positioned polarization maintaining (PM) or single mode (SM) fiber tip with a proximally positioned transducer, while the sensor component 150 of FIG. 2B, further includes a sequentially positioned chiral fiber circular polarizer with a PM optical fiber section therebetween and a SM fiber sensing tip on its other end, proximal to a transducer. The chiral fiber circular polarizer used in the sensor component 150 may be any of the circular polarizers disclosed in the co-pending commonly assigned U.S. patent application entitled “CHIRAL FIBER CIRCULAR POLARIZER” of Kopp et al., that is hereby incorporated by reference herein in its entirety.

Upon application of pressure to a transducer exceeding a predefined sensing criteria, the transducer transmits the pressure to the fiber tip of the sensing component, that distorts the polarization of either linearly or circularly polarized light being circulated through the chiral fiber sensor 10. This distorted polarization in turn changes the intensity of the light that is back-reflected through the chiral polarizer which is an analyzer in back-reflection. It should be noted that because the sensor component 100 is based solely on a linear polarizer, during active use thereof, the light transmission through the sensor 10 decreases as the pressure applied by the transducer increases, while because the sensor component 150 is based on a combination of a linear polarizer and a circular polarizer, during active use thereof, the light transmission through the sensor 10 increases as the pressure applied by the transducer increases.

It should also be noted, that as had been indicated above, the sensing components 100, 150 may be readily configured to sense temperature rather than pressure by providing an appropriately configured transducer thereto that comprises a predetermined mismatch between the thermal expansion coefficient thereof and that of the fiber tip of the corresponding sensing component.

Finally, it should further be noted that sensing through signal amplitude detection in a fiber is very challenging because the fiber may be subject to environmental factors that can affect fiber sufficiently to change the amplitude of the signals transmitted therethrough and thus render the sensor readings inaccurate. The chiral fiber sensor 10 of the present invention utilizes a shorter wavelength reference signal, which does not change with pressure—(e.g., if a 1310 nm wavelength light source is used, the signal amplitude will not be influenced by pressure and can thus serve as a reference signal greatly increasing the overall sensor 10 reliability.

For example, if the sensing component 150 is used in the sensor 10 of FIG. 1, if the sensing component 150 tip fiber is not stressed by the transducer, then the circulating light signal will consistently indicate a maximum reading, however as pressure is applied thereto, the amount of light at the higher wavelength (e.g. at 1,550 nm) will be reduced.

Thus, while there have been shown and described and pointed out fundamental novel features of the inventive apparatus as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claim(s) appended hereto.

We claim:

1. A configurable optical chiral fiber sensor, comprising:
at least one predefined compatible light source operable to generate a light signal having predefined polarization characteristics;
an optical fiber sensing component, operable to permit said light signal to be received from said at least one light source, and to be circulated therethrough;
at least one transducer means, positioned proximal to said optical fiber sensing component, for causing at least one corresponding distortion in said predefined polarization characteristics of said circulating light signal;
a sensor interrogation system, operable to detect said at least one distortion to produce a corresponding at least one sensor output; and
an optical fiber link of a predetermined length connected between said optical fiber sensing component and said sensor interrogation system.
